(19) United States
(12) Patent Application Publication
(10) Pub. No.: US 2004/0102225 A1
(43) Pub. Date: May 27, 2004

(54) Portable communication terminal and image display method

(75) Inventors: Shinichi Furuta, Tokyo (JP); Atsushi Honma, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/716,884

(22) Filed: Nov. 18, 2003

(30) Foreign Application Priority Data
Nov. 22, 2002 (JP) 2002-338783
Oct. 1, 2003 (JP) 2003-343504

(51) Int. Cl. H04B 1/38

(52) U.S. Cl. 455/566; 455/550.1

(57) ABSTRACT

In performing outgoing call log display by a cell phone, when display operation is performed in the order of the outgoing call log display state in FIG. 15A→FIG. 15C→FIG. 15B→FIG. 15D, and a clear key is operated in the detailed display state in FIG. 15B, the displays FIG. 15C in accordance with the operation log stored in a buffer instead of directly returning to FIG. 15A. When display operation is performed in the order of FIG. 15A→FIG. 15B→FIG. 15D, and the clear key is operated in FIG. 15B, FIG. 15A is displayed in accordance with the operation log stored in the buffer.

### CROSS-REFERENCE TO RELATED APPLICATIONS

This application is based upon and claims the benefit of priority from the prior Japanese Patent Applications No. 2002-338783, filed Nov. 22, 2002; and No. 2003-343504, filed Oct. 1, 2003, the entire contents of both of which are incorporated herein by reference.

### BACKGROUND OF THE INVENTION

1. Field of the Invention

The present invention relates to a radio communication terminal such as a portable communication terminal and an image display method in a communicational terminal and, more particularly, to a function of displaying an image photographed by, for example, a photographing function, together with contact address information such as a telephone number.

2. Description of the Related Art

Conventionally, a portable communication terminal categorized into a radio communication terminal has a display function corresponding to a caller ID system which displays a telephone number which is transmitted from the self terminal or received from a switching center when a communication request is generated.

Some portable communication terminals have an address book function, outgoing call log display function, and incoming call log display function which collate a called or received telephone number with data in the address book (phone book memory) of the self terminal and displays the name or the like of a terminal user who is a callee or caller if the telephone number coincides with any data.

More specifically, this address book function is a function of displaying a telephone number and information which is associated with a contact address specified by the telephone number, e.g., a name or the like stored in correspondence with the telephone number. The outgoing call log function and incoming call log function are functions of storing telephone numbers called and received by the self terminal and originating/terminating dates and displaying them in the form of a list in response to user operation.

Recently, some cell phones have been provided with an image display function to display an image such as a facial portrait of a terminal user corresponding to a telephone number when data is displayed by the address book function (e.g., patent reference 1).

In addition, some cell phones have been provided with an image sensing function to display a sensed image as information corresponding to a terminal user as a communication partner when a past communication log such as an outgoing call log or incoming call log is displayed (e.g., patent reference 2).

[patent reference 1]: Jpn. Pat. Appln. KOKAI Publication No. 2001-24776 (p. 5, FIG. 8)

[patent reference 2]: Jpn. Pat. Appln. KOKAI Publication No. 11-41339 (pp. 3-4, FIGS. 2 and 4)

Displaying images when address book data or a communication log is displayed in this manner is effective in making a user intuitively recognize a contact address user. On the other hand, when a terminal device having a small display screen, e.g., a cell phone, performs list display to make the user recognize a plurality of contact addresses, the display of such images occupies the display area, resulting in ineffective use of the display screen.

In addition, when the user wants to prevent others from seeing contact address users and the like, an address book or communication log must be displayed after settings are made to inhibit the display of images. This degrades the usability for the user.

### BRIEF SUMMARY OF THE INVENTION

It is an object of the present invention to provide a portable communication terminal and image display method which can flexibly switch between display and non-display of an image when contact address information or a communication log is displayed.

In order to achieve the above object, a portable communication terminal according to claim 1 comprises display means, image storage means for storing image data, address book data storage means for storing at least one piece of contact address information and various information associated with the contact address information upon establishing a link therebetween, storage means for storing a link between specific data in the address book data storage means and a storage address of image data stored in the image storage means, communication log storage means for storing, as a communication log, contact address information transmitted and/or received by the portable communication terminal, first instructing means for instructing to display a communication log on the display means, first display control means for, when detecting an instruction from the first instructing means, listing/displaying the contact address information stored in the communication log storage means on the display means, second instructing means for instructing to display a communication log with an image on the display means when list display is performed by the first display control means, first determination means for, when detecting an instruction from the second instructing means, referring to the storage means to determine whether image data is linked to the contact address information displayed on the display means, and second display control means for, when the determination means determines that image data is linked, reading out and resizing the image data and listing/displaying the data, together with the contact address information.

In addition, in order to achieve the above object, an image display method for a portable communication terminal including a display section, an image memory which stores image data, and an address book data memory according to claim 12 comprises a storage step of causing a predetermined memory to store a link between specific data in the address book data memory and a storage address of image data stored in the image memory, a communication log storage step of causing a communication log memory to store, as a communication log, contact address information transmitted and/or received by the portable communication terminal, a first instructing step of instructing to display a stored content of the communication log memory on the display section, a first display control step of, when detecting an instruction issued in the first instructing step, listing/displaying the contact address information stored in the communication log memory on the display section, a second instructing step of instructing to display a communication log with an image on the display section when list display is performed in the first display control step, a first determination step of, when detecting an instruction issued in the second instructing step, referring to the predetermined memory to determine whether image data is linked to the contact address information displayed on the display section, and a second display control step of, when it is determined in the determination step that image data is linked, reading out and resizing the image data and listing/displaying the data, together with the contact address information, on the display section.

### BRIEF DESCRIPTION OF THE SEVERAL VIEWS OF THE DRAWING

FIGS. 1A and 1B are a plan view and rear view showing an example of the arrangement of a cell phone (portable communication terminal) according to the first embodiment of the present invention;

FIG. 2 is a circuit diagram showing an example of the circuit arrangement of the cell phone in FIGS. 1A and 1B;

FIG. 3 is a schematic view showing an example of the arrangement of a RAM in FIG. 2;

FIG. 4 is a schematic view showing an example of the arrangement of an image memory in FIG. 3;

FIGS. 5A and 5B are views showing examples of the contents of an outgoing call log data storage area in FIG. 3, in which FIG. 5A shows an example in which outgoing calls were generated from address book data, and FIG. 5B shows an example in which telephone numbers which were input with a dial key and called are stored;

FIG. 6 is a view showing an example of the contents of an address book data storage area in FIG. 3;

FIG. 7 is a view showing an example of the contents of a link information storage area in FIG. 3;

FIG. 8 is a flow chart showing an operation sequence for registering an image in the address book of the cell phone in FIGS. 1A and 1B;

FIG. 9 is a flow chart showing a sequence for storing, in an image memory, an image photographed by the cell phone in FIGS. 1A and 1B;

FIG. 10 is a flow chart showing an operation sequence for displaying a facial portrait of a callee in an outgoing call log display window displayed on a display section in FIGS. 1A and 1B;

FIG. 11 is a view showing an outgoing call log display window (list display) displayed on the display section in FIGS. 1A and 1B;

FIG. 12 is a view showing a detailed display window displayed on the display section in FIGS. 1A and 1B;

FIG. 13 is a view showing an example of an outgoing call log window with photographs displayed on the display section in FIGS. 1A and 1B;

FIG. 14 is a view showing an example of an enlarged image data display window displayed on the display section in FIGS. 1A and 1B;

FIGS. 15A through 15D are views for explaining switching operation for outgoing call log display windows displayed on the display section in FIGS. 1A and 1B;

FIG. 16 is a view showing a detailed incoming call log display window displayed on the display section in FIGS. 1A and 1B;

FIG. 17 is a flow chart showing a sequence for storing, in an image memory, a moving image (moving image file) photographed by the cell phone in FIGS. 1A and 1B in the second embodiment;

FIG. 18 is a flow chart showing an operation sequence for playing back a moving image from the detailed display window displayed on the display section in FIGS. 1A and 1B in the second embodiment; and

FIG. 19 is a view showing an example of a moving image playback window displayed on the display section in FIGS. 1A and 1B in the second embodiment.

### DETAILED DESCRIPTION OF THE INVENTION

First Embodiment

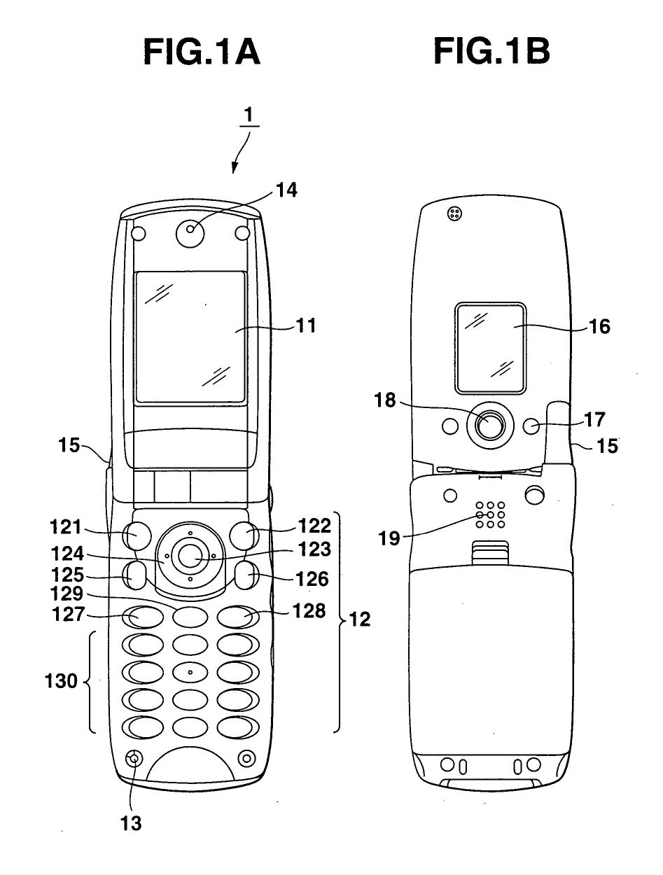

The embodiments of the present invention will be described below with reference to the several views of the accompanying drawing. FIGS. 1A and 1B are a plan view and rear view, respectively, showing an example of the arrangement of a cell phone serving as a portable communication terminal according to an embodiment of the present invention. A cell phone 1 is of a twofold type. FIG. 1A shows the front side of the phone in the unfolded state. FIG. 1B shows the rear surface of the phone in the unfolded state.

Referring to FIG. 1A, the cell phone 1 includes a liquid crystal display section 11 which displays various kinds of information such as graphic information and image information, a key operation section 12 which, for example, inputs various kinds of information and issues function instructions, a microphone 13 which picks up user's voice, a loudspeaker 14 which outputs partner's voice, and an antenna 15 for communication which is suited to the frequency band used by a radio protocol for cell phones.

Referring to FIG. 1B, this phone includes a sub-display section 16 for notifying a user of simple messages even in the folded state, a notification LED 17 which notifies the user of the reception of an incoming call, warning, and the like, a photographing lens 18 which photographs an object, and a notification loudspeaker 19 which outputs a ringing tone, warning sound, and the like.

Referring to FIG. 1A, the following keys are arranged in the key operation section 12: a camera key 121 which is operated to activate a specific function in each mode or to activate a camera mode, an address book key 122 which is operated to activate a specific function in each mode or to activate an address book mode, an accept key 123 which is operated to issue an instruction in each mode (the address book mode in this embodiment), a cursor key 124 for selecting operation in each mode (the address book mode in this embodiment), a mail key 125 for activating a mail mode, a Web key 126 for issuing an Internet connection instruction, an off-hook key 127, an on-hook key 128, a clear key 129, a dial key 130, a message memo/voice recording key 131, and a silent key 132.

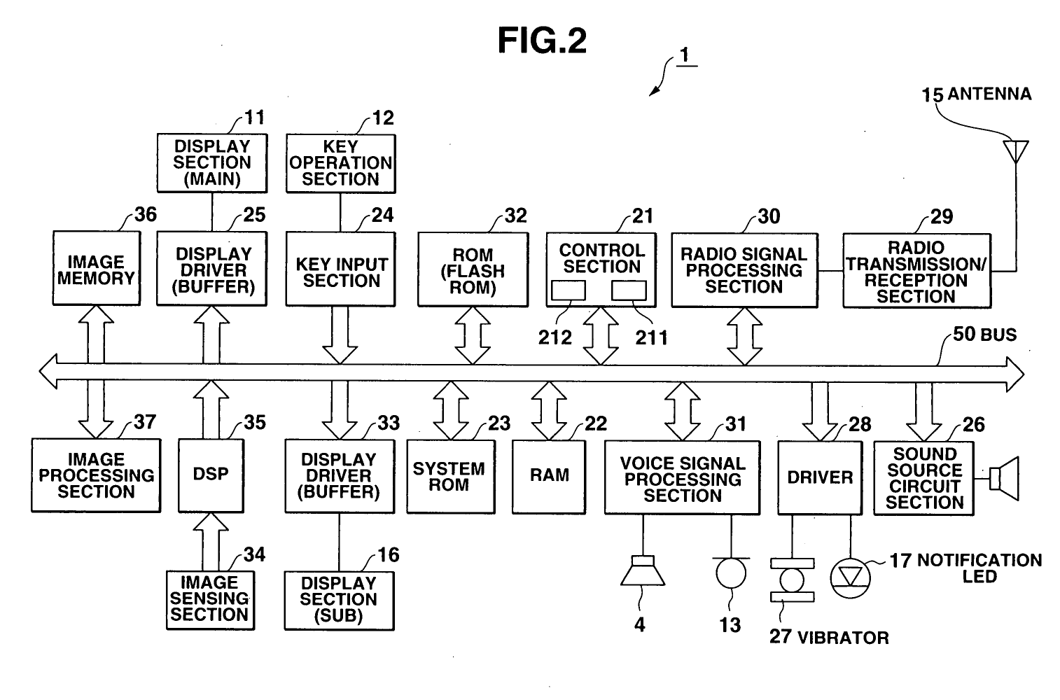

FIG. 2 is a circuit diagram showing an example of the circuit arrangement of the cell phone 1 shown in FIGS. 1A and 1B.

The circuit of the cell phone 1 includes a control section 21 which controls the individual operation and overall operation of the cell phone 1, a buffer 211 which stores the operation log of the key operation section 12 in each mode under the control of the control section 21, a buffer memory 212 which temporarily stores a telephone number extracted from an address book data storage area 223 of a RAM 22 (to be described later), the RAM 22 which stores various kinds of data necessary for the cell phone while storing data required for the control section 21 to operate, a system ROM 23 which stores various kinds of programs for controlling the control section 21, a key input section 24 which inputs key press information from the key operation section 12, a display driver (buffer) 25 which drives the display section 11 to display various kinds of information, a sound source circuit section 26 which generates various kinds of voice signals and outputs them through the notification loudspeaker 19, a driver 28 which drives the notification LED 17 and a vibrator 27 which notifies the user of an incoming call by vibration, a radio transmission/reception section 29 which transmits/receives voice and data to/from a base station (not shown) by radio through the antenna 15, a radio signal processing section 30 which performs processing necessary for radio communication, e.g., demodulating voice or data received by the radio transmission/reception section 29 or modulating voice or data to be transmitted from the radio transmission/reception section 29, a voice signal processing section 31 which codes a voice signal input from the microphone 13 or decodes a partner's voice signal, a rewritable ROM (flash ROM) 32 which stores various kinds of setting information input by the user and the like, a display driver 33 which drives the sub-display section 16 to display a simple message, an image sensing section 34 which converts an image photographed by the photographing lens 18 into an electrical signal through a CCD or the like, a DSP 35 which converts an electrical signal obtained from the image sensing section 34 into an image signal, an image memory 36 which stores an image sensed by the image sensing section 34, and an image processing section 37 which compresses/codes an image signal, and more specifically, compresses/codes a still image signal into a signal in the JPEG format and a moving image signal into a signal in the AMC format (a moving image file format conforming to the MPEG-4 format), and also decompresses image data in the JPEG format or data in the AMC format when they are loaded. These components are connected to each other through a bus 50.

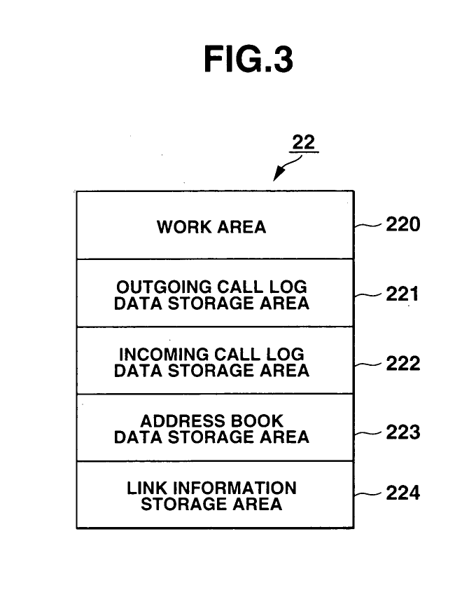

FIG. 3 is a schematic view showing an example of the arrangement of the RAM 22 in FIG. 2. In addition to a work area 220 for the control section 21, the following areas are set in the RAM 22: an outgoing call log data storage area 221 and incoming call log data storage area 222 in which past communication logs are stored, an address book data storage area 223, and a link information storage area 224.

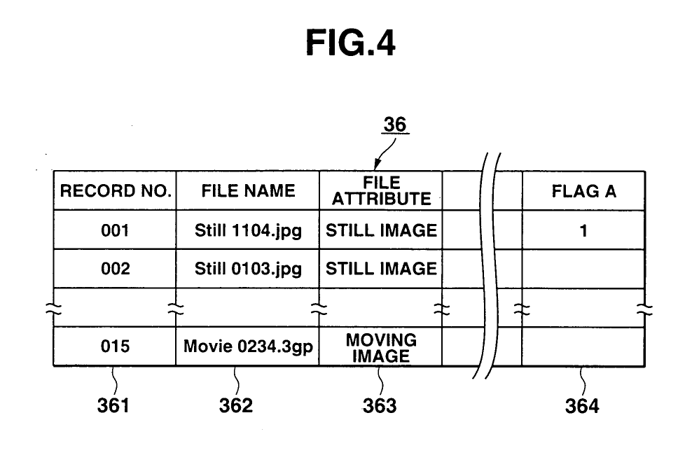

FIG. 4 is a schematic view showing an example of the arrangement of the image memory 36 in FIG. 3. In the memory area arrangement of the image memory 36, data are stored in each set of the following areas: a record No. area 361 serving as an image data storage address area, a file name storage area 362, a file attribute storage area 363 in which a file attribute indicating whether image data is a still image file or moving image file is stored, . . . , and a flag A area 364 which indicates the presence/absence of a link, i.e., whether or not link information is set for the corresponding image data. Flag A set to “1” indicates the presence of a link.

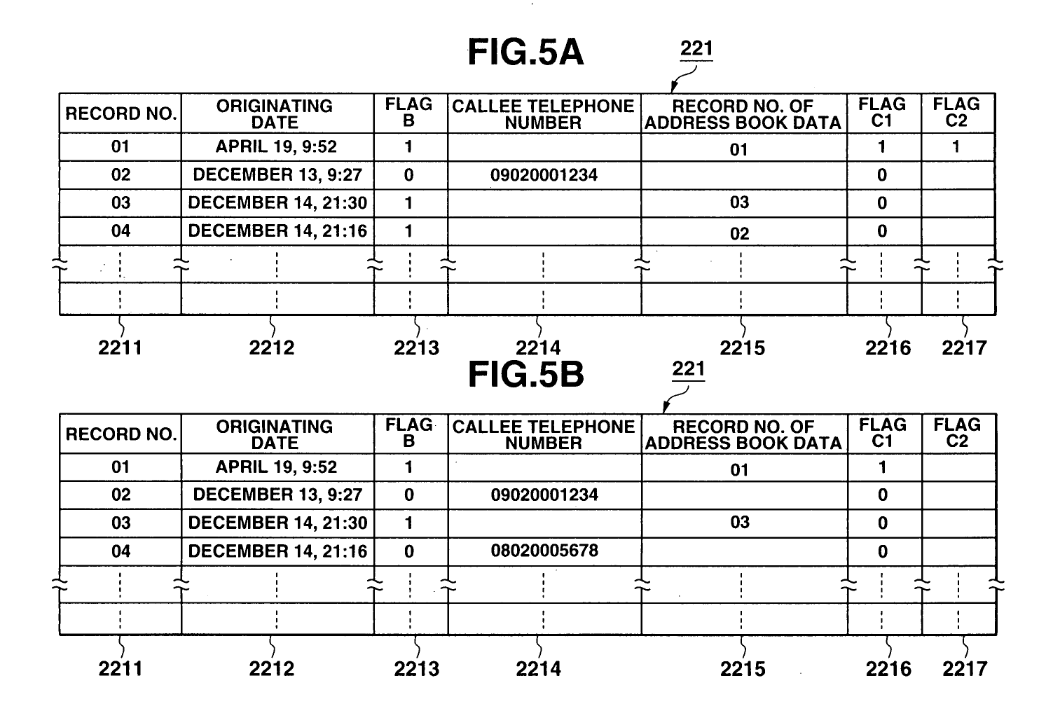

FIG. 5A is a schematic view showing an example of the arrangement of the outgoing call log data storage area 221 in FIG. 3. Referring to FIG. 5A, one outgoing call log record is constituted by a record No. area 2211 serving as a storage address area, an originating date area 2212, a flag B area 2213 indicating whether or not data corresponding to the address book data storage area 223 is present, a callee telephone number area 2214 in which a callee telephone number is stored at the time of originating operation when “0” is set in the flag B area 2213, i.e., no link is set, an area 2215 in which the record No. in the address book data storage area 223 is stored when “1” is set in the flag B area 2213, i.e., a link is set, a flag C1 area 2216 in which “1” is set to inhibit the user from erasing the corresponding outgoing call log record due to his/her operation error, and a flag C2 area 2217 in which “1” is set when the corresponding originating operation is data transmission using a short message service (SMS) instead of voice origination.

Consider a storage form of these data in a case wherein the data of “Yoko Akimoto” is read out from the address book on April 19, at 9:52, the corresponding telephone number “09012345678” is called, and an erasure lock is applied. In this case, “April 19, 9:52” is stored in the originating date area 2212 corresponding to record No. 01, and “1” is set in the flag B area 2213. Nothing is set in the callee telephone number area 2214. The record No. of “Yoko Akimoto” in the address book data storage area 223 is stored in the area 2215, and “1” is set in the flag Cl area 2216. When “09020001234” is called by directly detecting the operation of the dial key 130 on December 13, at 9:27, “December 13, 9:27” is stored in the originating date area 2212 corresponding to record No. 02, and “0” is set in the flag B area 2213. In addition, “09020001234” is set in the callee telephone number area 2214, nothing is set in the area 2215, and “0” is set in the flag C area.

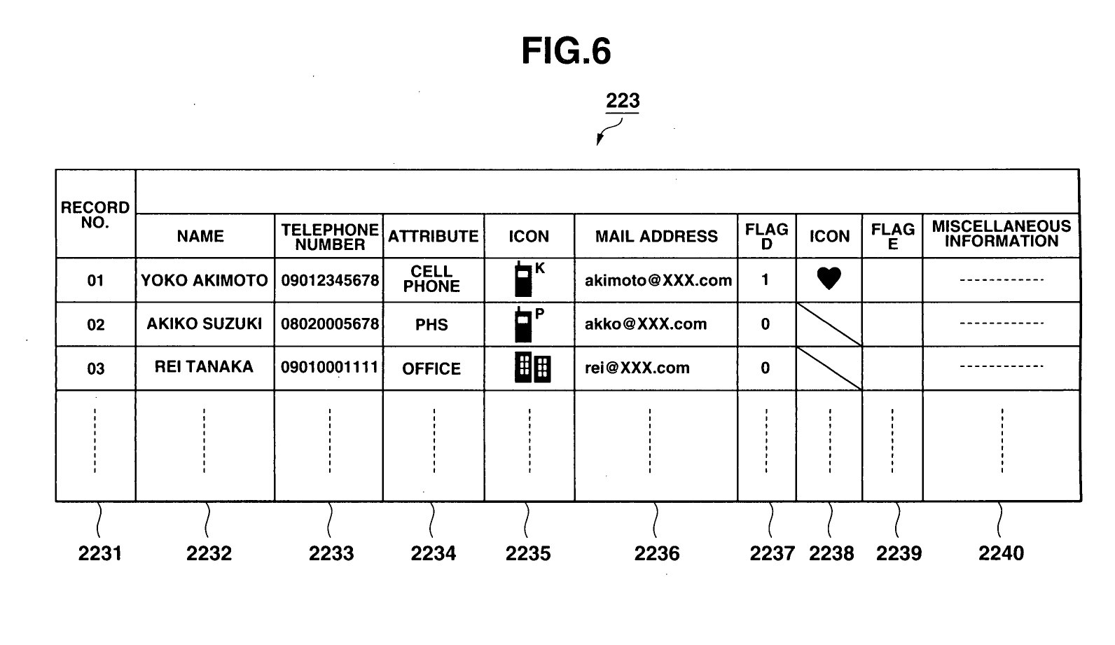

Note that even when a telephone number is directly input with the dial key 130 at the time of originating operation, the address book data storage area 223 shown in FIG. 6 is searched afterward for an identical telephone number. If there is an identical telephone number, the corresponding record No. is stored, and “1” is set in the flag B area 2213.

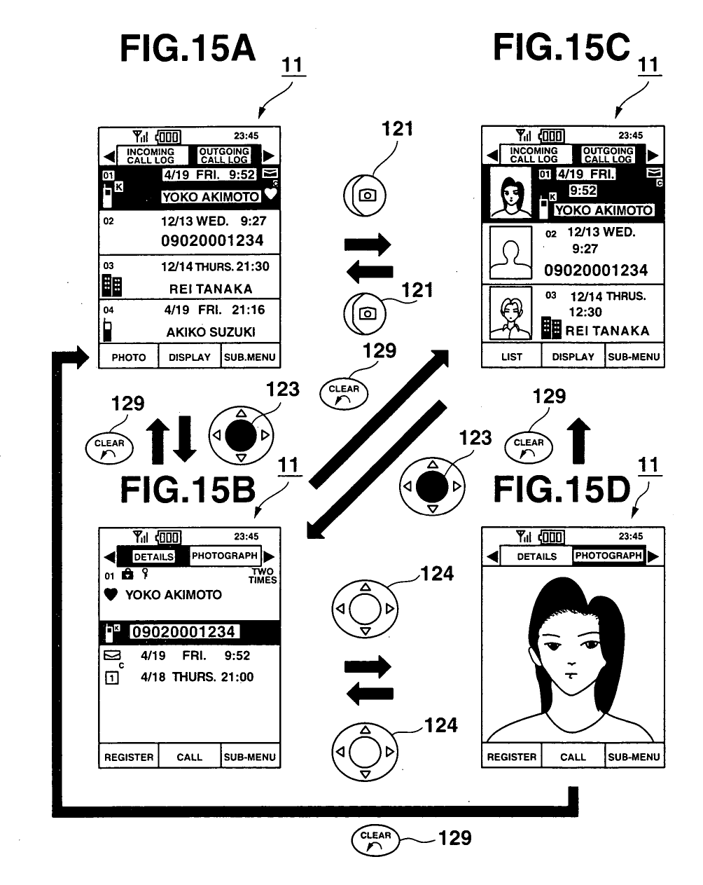

For example, FIG. 15B shows the outgoing call log data storage area 221 immediately after the telephone number “08020005678” is called upon detection of the direct operation of the dial key 130 on December 14, at 21:16. If a telephone number identical to the telephone number “08020005678” is present in the address book data after the originating operation, the record No. of the corresponding address book data is stored in place of the called telephone number, and “1” is set in the flag B area. This results in the stored state shown in FIG. 5A. An example of the arrangement of the incoming call log data storage area 222 in FIG. 3 conforms to the outgoing call log data storage area 221 except that a caller number received at the time of terminating operation is stored first in correspondence with the terminating date in place of a called telephone number. The address book data storage area 223 is searched afterward for a telephone number identical to this caller telephone number. If there is an identical telephone number, the corresponding record No. is stored, and flag “1” is set.

FIG. 6 is a schematic view showing an example of the arrangement of the address book data storage area 223 in FIG. 3. Referring to FIG. 6, one record is constituted by a record No. area 2231 serving as a storage address area, a name area 2232, a telephone number area 2233 serving as a communication partner information area, an attribute area 2234 indicating the attribute of the telephone number (whether the number is for a cell phone or fixed phone, private or business, or the like), an attribute icon area 2235 in which an icon is set in accordance with the attribute content of the attribute area 2234, a mail address storage area 2236 in which a mail address as communication partner information is stored, a flag D area 2237 in which “1” or “0” is set depending on whether the corresponding person belongs to some kind of group in address book data, an icon area 2238 in which a display icon plainly indicating a group is set when “1” is set in the flag D area 2237, a flag E area 2239 in which “1” is set when the corresponding record is secrete data, and a miscellaneous information area 2240 in which data that is not limited to data essential for the address book function, e.g., the relationship with the user of the cell phone 1 such as friend or parent or a date of birth, is stored.

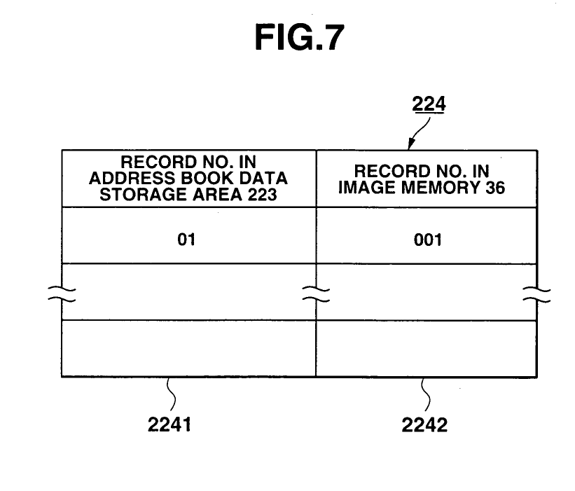

FIG. 7 is a schematic view showing an example of the arrangement of the link information storage area 224 in FIG. 3. Referring to FIG. 7, a record No. area 2241 registered in the address book data storage area 223 is linked to a record No. area 2242 in which a record No. in the image memory 36 is stored.

The operation of this embodiment will be described next with reference to the several views of the accompanying drawing.

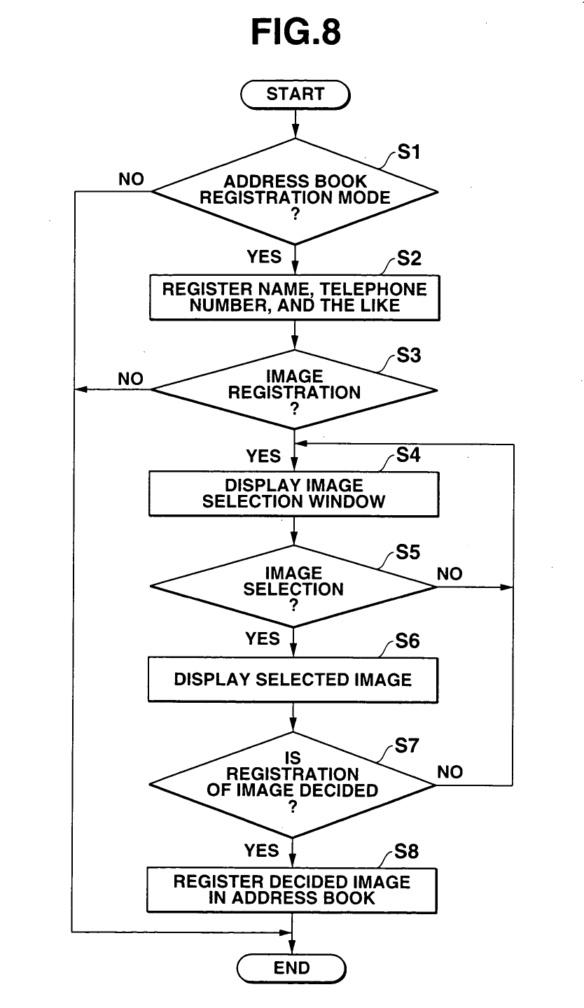

FIG. 8 is a flow chart for explaining an operation sequence for registering an image when the current operation mode shifts to the address book mode upon detection of the operation of the address book key 122 in a termination standby state. Assume that the user wants to display an image such as a facial portrait of a callee in an outgoing call/incoming call log window or display an image such as a facial portrait of a caller. In this case, first of all, the user makes settings to display an image associated with the callee or caller.

Upon detection of the operation of the address book key 122, the cell phone 1 displays a menu of functions (not shown) prepared in the address book mode. The user sees this menu display, and selects a desired function by operating the cursor key 124. The user then presses the accept key 123 to decide the function. When, therefore, a shift from the menu display to a address book registration mode by the user operation is detected, the current operation mode shifts to the address book registration mode. In step S1, the control section 21 checks whether the address book registration mode is set. If the address book registration mode is set, the control section 21 displays a registration window on the display section 11 in step S2. The control section 21 then registers information associated with a contact address, e.g., the telephone number and name input by the user, in the address book data storage area 223 (FIG. 3) of the RAM 22.

In this case, when the user wants to display, in the outgoing call/incoming call log window, an image such as a facial portrait of a person whose name has been registered, he/she further selects image registration. Upon determining the image registration in step S3, the control section 21 accesses the image memory 36 to display an image selection window in step S4. This image selection window displays the image data stored in the image memory 36 in the form of, for example, thumbnails. When the user sees this window and selects an image to be displayed, the control section 21 determines image selection in step S5, and displays the image in the corresponding box in the address book registration window in step S6.

When the user sees this window and approves of it, he/she performs deciding operation. Otherwise, the user performs returning operation to return to the image selection. In response to this operation, if the control section 21 determines in step S7 that the registration of the image has been decided, the flow advances to step S8. Otherwise, the flow returns to the processing in step S4.

In step S8, the control section 21 generates link information (to be described later) for linking a record No. of the address book to the record No. of image data registered in association therewith, and registers the information in the link information storage area 224 (shown in FIG. 7) of the RAM 22. The control section 21 also sets “1” in the flag A area 364 of the image memory 36 shown in FIG. 4 and terminates the processing.

Operation of storing, in the image memory 36, an image obtained by using the photographing function of the cell phone 1 will be described next.

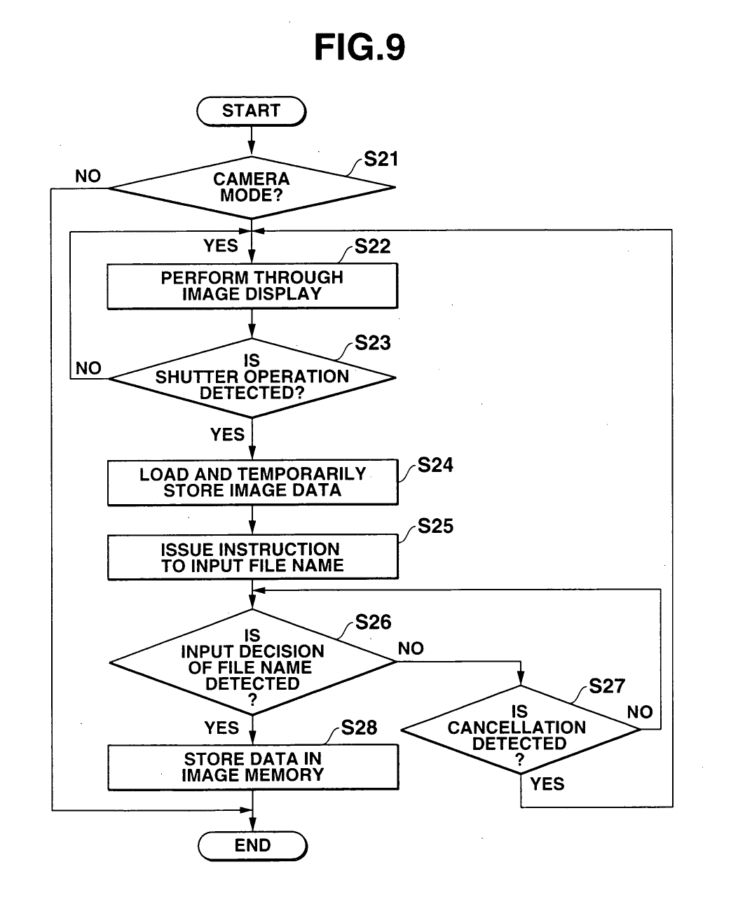

FIG. 9 is a flow chart showing a sequence for storing a photographed image in the image memory 36. In photographing an object, the user operates the key operation section 12 of the cell phone 1 to shift to the camera mode. Upon determining in step S21 that the camera mode is set, the control section 21 performs through display of image data obtained by the DSP 35 from an electrical signal obtained by photographing the object using the image sensing section 34 on the display section 11 through the driver 25 in step S22.

Subsequently, the control section 21 checks in step S23 whether the camera key 121 is operated. If NO in step S23, the flow returns to step S22. If YES in step S23, the control section 21 loads the image data, output from the DSP 35 when the camera key 121 is pressed, into the work area 220 and temporarily stores it in step S24. At the same time, the control section 21 displays the image data obtained by the DSP 35 on the display section 11 through the display driver 25.

After displaying, to the user, a file name input instruction on the display section 11 in step S25, the control section 21 checks in step S26 whether or not the input decision of a file name is detected. If YES in step S26, the flow advances to the processing in step S28. If NO in step S26, the flow advances to step S27 to check whether or not a cancellation is detected. If NO in step S27, the flow returns to the processing in step S25. If YES in step S27, the flow returns to the processing in step S22.

In step S28, the control section 21 causes the image processing section 37 to compress/code the loaded image into a still image file in the JPEG format, and stores it in the image memory 36 upon attaching the file attribute “still image” to the file.

Although the above description has exemplified a case wherein image data is obtained by using the photographing function of the cell phone 1 and is stored in the image memory 36, the image data to be stored in the image memory 36 may be reception image data sent by e-mail or the like from another cell phone through the radio transmission/reception section 29 and radio signal processing section 30 or image data obtained by accessing a site on the Internet and downloading desired image data from the site by using a WWW (World Wide Web) connection function.

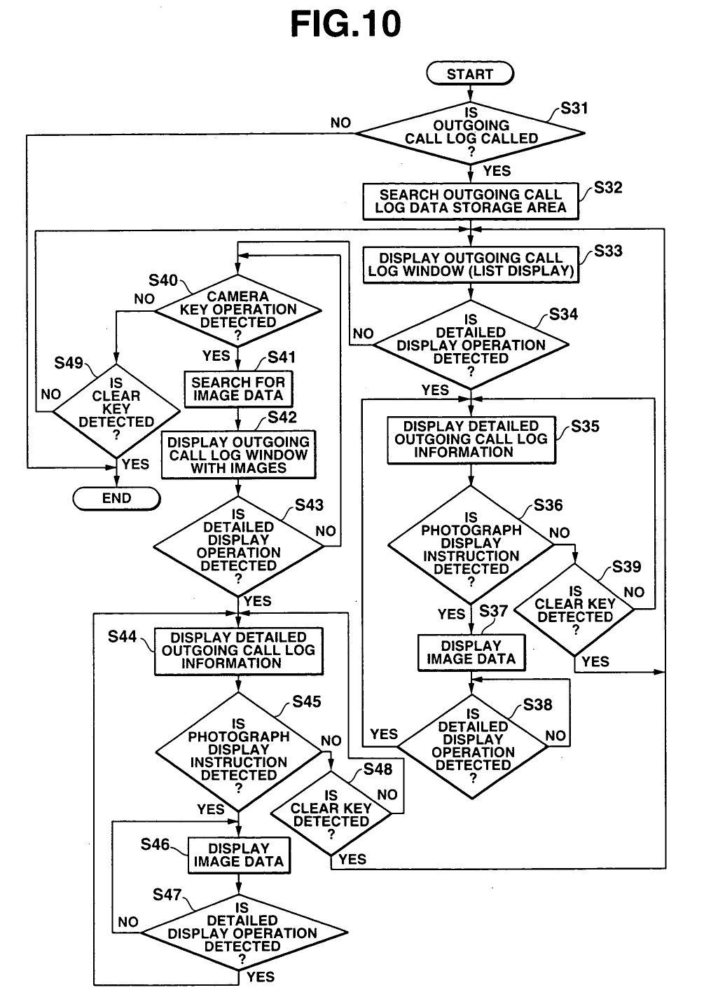

An operation sequence for displaying a facial portrait of a callee in the outgoing call log window will be described next with reference to the flow chart of FIG. 10. An operation log of the key operation section 12 in this operation sequence is sequentially recorded on the buffer 211 in FIG. 2 until the end of this mode is detected. When the user makes a telephone call with the cell phone 1, the control section 21 sequentially stores the callee telephone number in the outgoing call log data storage area 221 of the RAM 22 together with the originating date. When the user generates an outgoing call by selecting a desired telephone number in the address book mode, the record No. of address book data at which the called telephone number is stored is stored in the outgoing call log. When the user generates an outgoing call by directly inputting a telephone number operating the dial key 130, the telephone number is stored first. The control section 21 then collates the telephone number stored in the outgoing call log data storage area 221 with the telephone numbers stored in the address book data storage area 223. If there is an identical telephone number in the address book data, a record No. corresponding to the address book data is stored in placed of the called telephone number.

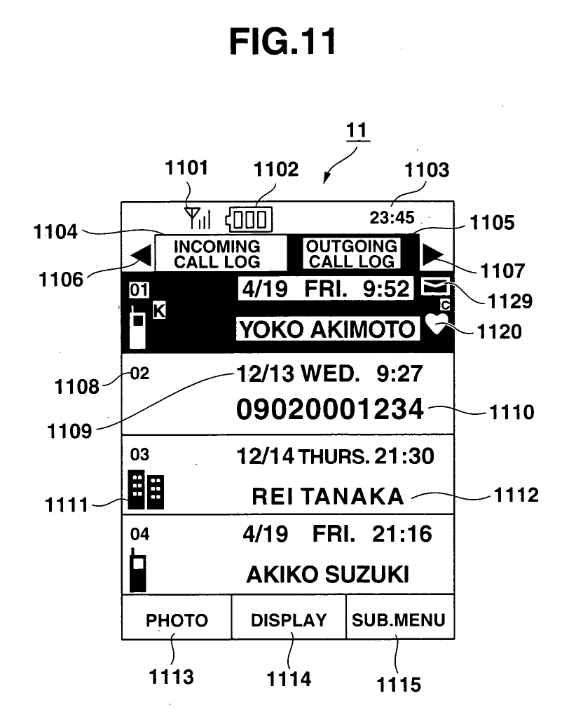

Subsequently, the user operates the key operation section 12 to call the outgoing call log display window. Upon detecting the call for the outgoing call log in step S31, the control section 21 clears the buffer 211, and searches the outgoing call log data storage area 221 shown in FIG. 3 to call data in originating date order in step S32. In step S33, the control section 21 displays the originating dates and callee telephone numbers or the names of the callees, when reading from the address book data, as an outgoing call log like the one shown in FIG. 11 in the form of a list.

FIG. 11 shows a window in which dates and callees (telephone numbers or names) are displayed in the form of a list. Referring to FIG. 11, the display section 11 displays an icon 1101 indicating a radio reception state, an icon 1102 indicating the remaining battery capacity, a current time 1103, an “incoming call log” tab 1104, an “outgoing call log” tag 1105, an icon 1106 for scrolling the list in the forward direction, an icon 1107 for scrolling the list in the reverse direction, a record No. 1108 displayed in correspondence with the stored content of the record No. area 2211 in FIG. 5, an originating date 1109 displayed in correspondence with the stored content of the originating date area 2212 in FIG. 5, a telephone number 1110 displayed in correspondence with the stored content of the callee telephone number area 2214 in FIG. 5, an icon 1111 indicating the content of the attribute icon area 2235 in FIG. 6 when the telephone number is stored in the address book data storage area 223, information 1112 indicating the content of the corresponding name area 2232 when the telephone number is stored in the address book data storage area 223, a display area 1113 for, when an instruction is to be issued to display an outgoing call log window with images, prompting the user to operate the camera key 121 as the corresponding key, a display area 1114 for, when an instruction is to be issued to display detailed data, prompting the user to operate the accept key 123 as the corresponding key, a display area 1115 for, when an instruction is to be issued to perform data editing, e.g., editing/deleting/registering highlighted data, prompting the user to operate the address book key 122, an icon 1129 displayed in accordance with the setting content of the flag C2 area 2217 in FIG. 5, and an icon 1120 indicating the content of the icon area 2238 in FIG. 6.

Note that the instruction contents of the “incoming call log” tab 1104, “outgoing call log” tag 1105, icon 1106, and icon 1107 are switched depending on the detection of the leftward/rightward operation of the cursor key 124. Assume that in the state shown in FIG. 11 wherein the outgoing call log is displayed in the form of a list, the rightward operation of the cursor key 124 is detected. In this case, if data corresponding to record No. 05 and subsequent record Nos. are stored in the outgoing call log data storage area 221, the data corresponding to record Nos. 05 through 08 are displayed in the form of a list. If the leftward operation of the cursor key 124 is detected, data corresponding to record Nos. 01 through 04 in the incoming call log data storage area 222 are displayed in the form of a list.

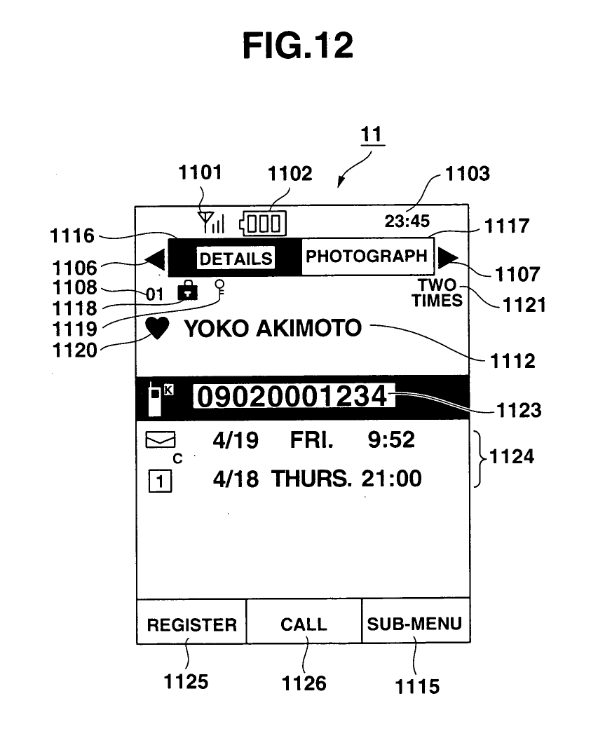

Assume that in this window in which the outgoing call log is displayed in the form of a list, in step S34, the control section 21 highlights the data desired by the user upon detecting the downward/upward operation of the cursor key 124, and detects an instruction for detailed display by detecting the operation of the accept key 123. In this case, in step S35, the control section 21 displays detailed outgoing call information corresponding to the selected outgoing call information portion (highlighted portion) in the outgoing call log, as shown in FIG. 12.

FIG. 12 shows a state wherein only one piece of outgoing call information selected in the list display window in FIG. 11 is displayed in the entire window, i.e., a display state of detailed information. Referring to FIG. 12, the display section 11 displays the icon 1101 indicating a radio reception state, the icon 1102 indicating the remaining battery capacity, the current time 1103, a “details” tab 1116, a “photograph” tab 1117, the icon 1106 for scrolling the detailed information in the forward direction in list order, the icon 1107 for scrolling the detailed information in the reverse direction in list order, the record No. 1108 displayed in correspondence with the stored content of the record No. area 2211 in FIG. 5, an icon 1118 displayed in accordance with the setting content of the flag C1 area 2216 in FIG. 5, an icon 1119 displayed in accordance with the setting content of the flag E area 2239 in FIG. 6, the icon 1120 indicating the content of the icon area 2238 in FIG. 6, data 1121 indicating a communication state, i.e., how many times the same telephone number was called in the past, the information 1112 indicating the content of the name area 2232 in FIG. 6, a telephone number 1123 indicating the content of the telephone number area 2233 in FIG. 6, contents 1124 of past outgoing calls to this callee which are stored in the outgoing call log data storage area 221, a display area 1125 for, when this outgoing call log is to be newly registered in the address book data storage area 223, prompting the user to operate the camera key 121 as the corresponding key, a display area 1126 for, when this telephone number is to be called again, prompting the user to operate the accept key 123 as the corresponding key, and the display area 1115 for, when an instruction is to be issued to perform data editing, e.g., editing/deleting/registering highlighted data, prompting the user to operate the address book key 122.

Note that the instruction contents of the “details” tab 1116, “photograph” tab 1117, icon 1106, and icon 1107 are interchanged depending on the detection of the leftward/rightward operation of the cursor key 124. If, for example, the rightward operation of the cursor key 124 is detected in the state shown in FIG. 12 in which the detailed information is displayed, image data corresponding to that record No. in the image memory 36 which is associated with this displayed information in FIG. 7 is displayed in the entire window. If the leftward operation of the cursor key 124 is detected, the next data in the outgoing call log data storage area 221 is displayed in detail if it is stored therein.

Upon detecting the selection of “photograph” on the upper right portion in the window by detecting the leftward/rightward operation of the cursor key 124 in the above detailed display window, the control section 21 determines in step S36 that an instruction has been issued to display an image associated with this outgoing call information, and makes a search to check whether link to any image data is registered (registered=“1”) in correspondence with the record No. of the displayed information in the address book data storage area 223.

If it is determined as a result of the search that the link to image data is registered, the control section 21 searches the link information storage area 224 for the image data stored in the image memory 36 by using, as a key, that record No. in the image memory 36 which is linked to the record No. in the incoming call log data storage area 222.

That is, the control section 21 checks the presence/absence of data link registration in the outgoing call log data storage area 221, and further checks, by referring to the link information storage area 224, whether a record No. in the image memory 36 is linked to the record No. of this linked/registered address book data. If the record linked, the control section 21 searches for a file name on the basis of the linked and registered record No. in the image memory 36.

The control section 21 then searches the image memory 36 shown in FIG. 4 by using the record No. in the image memory 36 as a search key to read out image in accordance with the storage information field in which a flag is set.

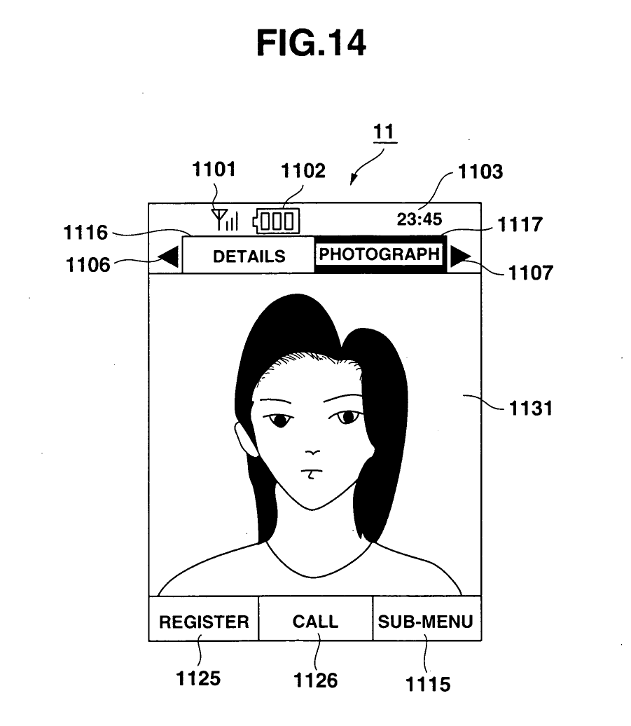

In step S37, the control section 21 reads out the image data stored in the above file in the image memory 36 and resizes it to display it as shown in FIG. 14. If no link to data is registered, the control section 21 checks in step S39 whether or not the operation of the clear key 129 is detected. If the operation of the clear key 129 is detected, the flow returns to the list display processing in step S33. If the operation of the clear key 129 is not detected, the control section 21 keeps displaying the detailed outgoing call information in step S35.

When the control section 21 detects the selection of “details” on the upper left portion in the window upon detecting the leftward/rightward operation of the cursor key 124 by the user in the display state of the image data in step S37, the flow shifts to display of detailed outgoing call information in step S35. If no such operation is detected, the control section 21 keeps displaying the image data.

If no detailed display instruction is detected in step S34, the control section 21 checks in step S40 whether or not the operation of the camera key 121 is detected. If the operation of the camera key 121 is detected, the flow advances to step S41. Otherwise, the control section 21 checks in step S49 whether or not the operation of the clear key 129 is detected.

If the operation of the camera key 121 is detected, the control section 21 refers to the setting contents in the flag B area to check in step S41 whether or not the address book data storage area 223 contains any corresponding data of all the outgoing call log data displayed in the form of a list. With regard to data having link information, in order to check whether or not corresponding image data is present in the image memory 36, the control section 21 searches the link information storage area 224 by using the record Nos. of address book data as search keys.

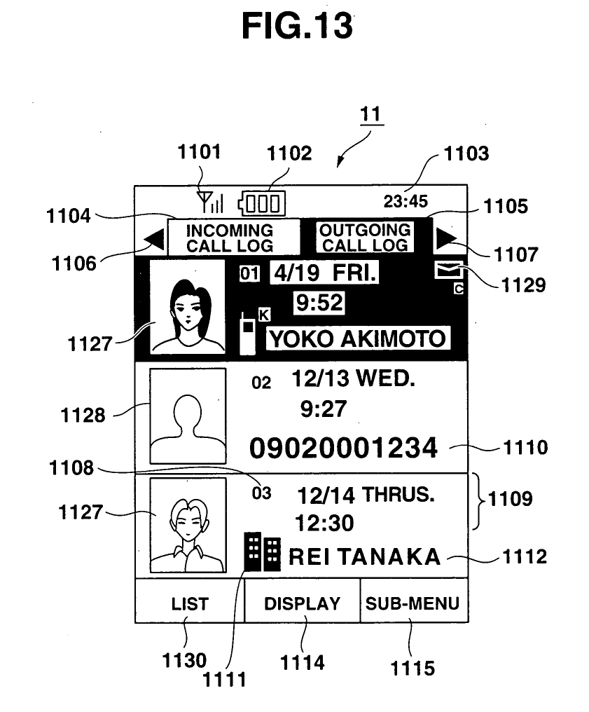

As a result of the search, with regard to record Nos. by which image data are searched out, the control section 21 reads out the image data from the image memory 36 and resizes them. With regard to record Nos. by which no image data is searched out, the control section 21 reads out prepared dummy images. In step S42, the control section 21 then displays an outgoing call log window with images like the one shown in FIG. 13.

FIG. 13 shows the outgoing call log window with images which is obtained in step S42. Referring to FIG. 13, the display section 11 displays the icon 1101 indicating a radio reception state, the icon 1102 indicating the remaining battery capacity, the current time 1103, the “incoming call log” tab 1104, the “outgoing call log” tag 1105, the icon 1106 for scrolling the list in the forward direction, the icon 1107 for scrolling the list in the reverse direction, the record No. 1108 displayed in correspondence with the stored content of the record No. area 2211 in FIG. 5, the originating date 1109 displayed in correspondence with the stored content of the originating date area 2212 in FIG. 5, the telephone number 1110 displayed in correspondence with the stored content of the callee telephone number area 2214 in FIG. 5, the icon 1111 indicating the content of the attribute icon area 2235 in FIG. 6 when the telephone number is stored in the address book data storage area 223, the information 1112 indicating the content of the corresponding name area 2232 when the telephone number is stored in the address book data storage area 223, image data 1127 and dummy image 1128 which are read out from the image memory 36 and resized, an icon 1129 displayed in accordance with the setting content in the flag C2 area 2217 in FIG. 5, a display area 1130 for, when an instruction is to be issued to display an outgoing call log in the form of a list as shown in FIG. 11, prompting the user to operate the camera key 121 as the corresponding key, the display area 1114 for, when an instruction is to be issued to display detailed data, prompting the user to operate the accept key 123 as the corresponding key, and the display area 1115 for, when an instruction is to be issued to perform data editing, e.g., editing/deleting/registering highlighted data, prompting the user to operate the address book key 122.

The display form shown in FIG. 13 is similar to the list display in step S33, but the number of outgoing call log data displayed in one window decreases. More specifically, since image data is displayed in correspondence with each outgoing call log data, the number of data per window becomes smaller than that in step S33. However, each image data is resized into the minimum display range that can be visually recognized. With regard to the respective data, even list display therefore allows the user to check at a glance to whom he/she has generated an outgoing call.

Upon detecting the upward/downward operation of the cursor key 124 in this outgoing call log window with images in step S43, the control section 21 highlights the data desired by the user. Upon detecting a detailed display instruction by detecting the operation of the accept key 123, the control section 21 displays detailed outgoing call information corresponding to the selected outgoing call information portion (highlighted portion) in the outgoing call log as shown in FIG. 12 in step S44.

Upon detecting the selection of “photograph” on the upper right portion in the window by detecting the leftward/rightward operation of the cursor key 124 in the detailed display window displayed in the above manner, the control section 21 determines in step S45 that an instruction has been issued to display an image associated with the outgoing call information, and resizes again the image data, which has been resized/displayed in the outgoing call log window with images, to enlarge/display the image. In step S46, image data 1131 resized as shown in FIG. 12 is displayed on the display section 11.

When the control section 21 detects the operation of the clear key 129 in step S48 without detecting the above operation, the flow returns to the list display processing in step S33. If no operation is detected, the detailed display is maintained. With regard to outgoing call log data having a dummy image displayed in the outgoing call log window with images, even if the selection of “photograph” on the upper right portion in the window is detected by detecting the operation of the cursor key 124 by the user and decision by the operation of the accept key 123 is detected, NOP (No Operation) is determined.

If the control section 21 detects the selection of “details” on the upper left portion in the window by detecting the leftward/rightward operation of the cursor key 124 by the user in step S47 in the display state of this image data, the flow returns to the detailed outgoing call information in step S44. Otherwise, the control section 21 keeps displaying the image data.

Upon detecting the operation of the clear key 129 in step S49, the control section 21 determines that the display mode for the outgoing call log is canceled, and clears the buffer 211. Otherwise, the control section 21 maintains the list display operation in step S33.

In response to switching of the above outgoing call log display window, as shown in FIGS. 15A through 15D, display windows can be flexibly interchanged. Note that FIGS. 15A, 15B, 15C, and 15D correspond to FIGS. 11, 12, 13, and 14, respectively.

Assume that the outgoing call log display state shown in FIG. 15A is switched to 15C→15B→15D. In this case, when the clear key 129 is operated in the window shown in FIG. 15B, the window in FIG. 15A is not restored but the window in FIG. 15C is displayed in accordance with the operation log stored in the buffer 211. Assume that the outgoing call log display state shown in FIG. 15A is switched to the window in FIG. 15B→the window in FIG. 15D. In this case, when the clear key 129 is operated in the window in FIG. 15B, the window in FIG. 15A is displayed in accordance with the operation log stored in the buffer 211.

According to this embodiment, therefore, when the user wants to prevent others from seeing images as much as possible, as in a case wherein he/she uses the cell phone 1 outdoors, he/she can check a plurality of outgoing call logs at a glance without displaying the outgoing call log window with images in FIG. 15C by switching the windows in the order of FIG. 15A→15B→15D. When the user wants to check data in a window with images, he/she can intuitively understand a plurality of outgoing call logs in the outgoing call log window with images in FIG. 15C by switching the windows in the order of 15A→15C→15B→15D.

In this embodiment, the display form of an outgoing call log as a past communication record has been described in detail. A similar display form can also be realized for the mode of displaying an incoming call log. This is because the arrangement of the incoming call log data storage area 222 is the same as that of the address book data storage area 223 except that a caller telephone number (telephone number specifying a caller) received at the time of terminating operation is stored in place of a called telephone number.

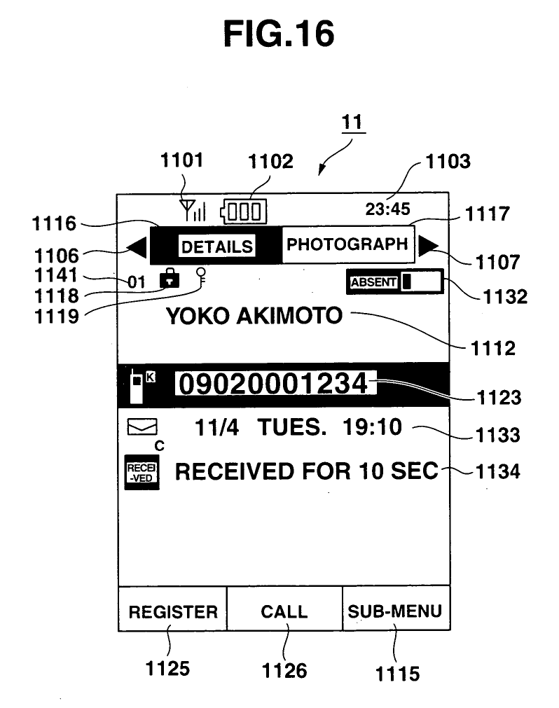

FIG. 16 shows an example of the detailed display of incoming call log contents. Referring to FIG. 16, the display section 11 displays the icon 1101 indicating a radio reception state, the icon 1102 indicating the remaining battery capacity, the current time 1103, the “details” tab 1116, the “photograph” tab 1117, the icon 1106 for scrolling the detailed information in the forward direction in list order, the icon 1107 for scrolling the detailed information in the reverse direction in list order, a record No. 1141 displayed in correspondence with a record No. area of the incoming call log data, an icon 1132 explicitly indicating the time taken between the detection of an incoming call and cancellation when no response is detected as a communication state at the time of terminating operation or a response is canceled at the time of terminating operation, the icon 1118 displayed in accordance with the setting content of the flag Cl area 2216 in FIG. 5, the icon 1119 displayed in accordance with the setting content of the flag E area 2239 in FIG. 6, the information 1112 indicating the content of the name area 2232 in FIG. 6, the telephone number 1123 indicating the content of the telephone number area 2233 in FIG. 6, a past incoming call content 1133 stored in the incoming call log data storage area 222, a time 1134 taken between the reception of an incoming call and cancellation, the display area 1125 for, when this incoming call log is to be newly registered in the address book data storage area 223, prompting the user to operate the camera key 121 as the corresponding key, the display area 1126 for, when this telephone number is to be called again, prompting the user to operate the accept key 123 as the corresponding key, and the display area 1115 for, when an instruction is to be issued to perform data editing, e.g., editing/deleting/registering highlighted data, prompting the user to operate the address book key 122.

In the address book display mode as well, since link information stored in the link information storage area 224 is referred to, display and the like of image data can be flexibly performed as in the case of an outgoing call log.

In this embodiment, a detailed description has been made on the case wherein when an outgoing call log is displayed, image data are displayed in the form of still images. However, the present invention is not limited to this. Moving image data may be displayed. Such a case will be described in detail below.

(Second Embodiment)

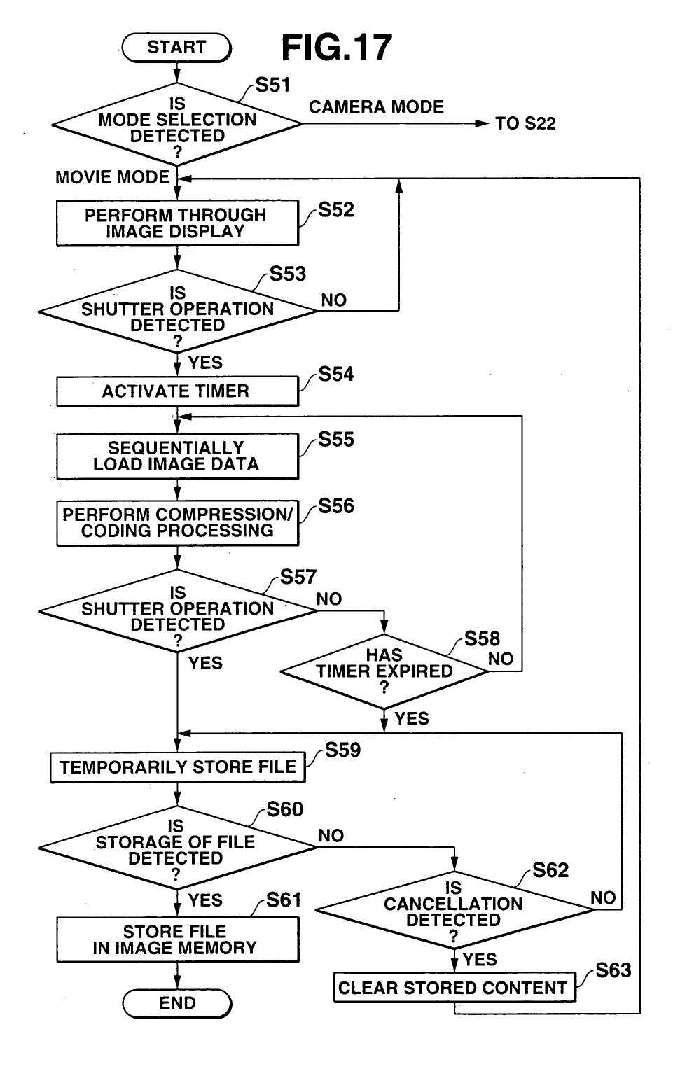

An embodiment of the present invention will be described in detail below with reference to FIGS. 17 through 19. However, since the circuit arrangement and the operation sequence for displaying a facial portrait of a callee in an outgoing call log display screen are almost the same as those in the first embodiment, a description thereof will be omitted.

Operation of storing a moving image obtained by using the photographing function of a cell phone 1 in an image memory 36 will be described first.

FIG. 17 is a flow chart showing a sequence for storing a photographed moving image in the image memory 36. When the user wants to take a movie of an object, he/she operates a key operation section 12 of the cell phone 1 to shift to a camera mode. After the camera mode is set, the execution/non-execution of mode selection is determined by detecting the operation of a camera key 121 in step S51. If the operation is detected, the current operation mode shifts to a movie mode. Note that if the operation of the camera key 121 is not detected, the flow advances to processing associated with the camera mode shown in FIG. 9.

If the shift to the movie mode is detected in step S51, a control section 21 performs through display of image data obtained by a DSP 35 from an electrical signal obtained by photographing the object using an image sensing section 34 on a display section 11 through a driver 25 in step S52.

Subsequently, the control section 21 checks in step S53 whether the camera key 121 is operated. If NO in step S53, the flow returns to the processing in step S52. If YES in step S53, the control section 21 activates in step S54 a timer to load a photographed image for a predetermined period of time from the point of time when the camera key 121 is pressed. In step S55, image data sequentially output from the DSP 35 are sequentially loaded into a work area 220 of a RAM 22. In addition to this operation, in step S56, the control section 21 causes an image processing section 37 to compress/code the image data sequentially input to the work area 220 to generate a moving image file in the AMC format.

Whether or not moving image photographing is complete is determined first by checking in step S57 whether or not shutter operation is detected upon operation of the camera key 121.

If shutter operation is detected in step S57, the control section 21 immediately stops the operation of the image sensing section 34 and DSP 35. In step S59, the control section 21 temporarily stores the compressed/coded moving image file in the work area 220 again. Even if shutter operation is not detected in step S57, the control section 21 discriminates in step S58 whether or not the timer activated in step S54 has expired. If the timer has expired, the control section 21 immediately stops the operation of the image sensing section 34 and DSP 35, and temporarily stores the moving image file compressed/coded in step S59 in the work area again. If no shutter operation is detected and the timer has not expired, the flow returns to the processing in step S55 again.

The control section 21 detects the operation of an accept key 123 in the state in step S59 to check in step S60 whether or not the storage of the moving image file is detected. If the storage is detected, the control section 21 stores the file in the image memory 36 upon attaching the file attribute “moving image” to the file in step S61.

If the storage is not detected in step S60, the control section 21 detects the operation of a clear key 129 to check in step S62 whether or not cancellation is detected. If cancellation is detected, the control section 21 erases the moving image file temporarily stored in the work area 220 in step S63, and the flow returns to step S52. If no cancellation is detected, the flow returns to step S59.

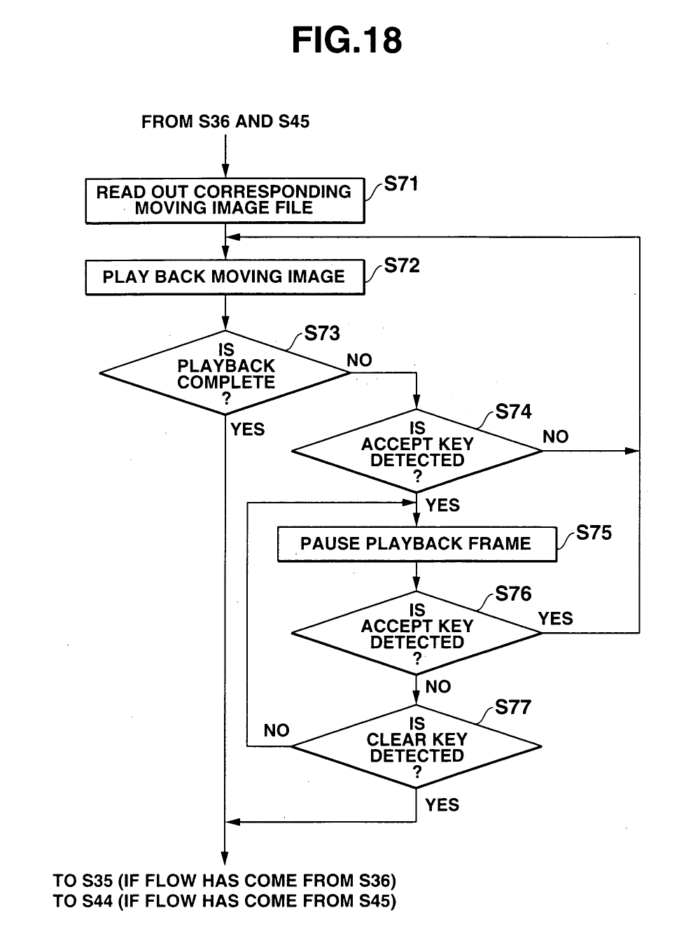

A case wherein the moving image file generated in FIG. 17 is linked to a predetermined record No. in an address book data storage area 223 while an outgoing call log is displayed will be described in detail next with reference to the flow chart of FIG. 18.

The operation in this flow chart which corresponds to that in steps S36 through S45 in FIG. 10 is the same as that in the first embodiment. That is, upon determining in step S36 that an instruction has been issued to display an image associated with outgoing call information in the detailed display state in FIG. 12, the control section 21 searches the address book data storage area 223 to check whether image data is linked/registered (registered=“1”) in correspondence with the record No. of this displayed information in the address book data storage area 223.

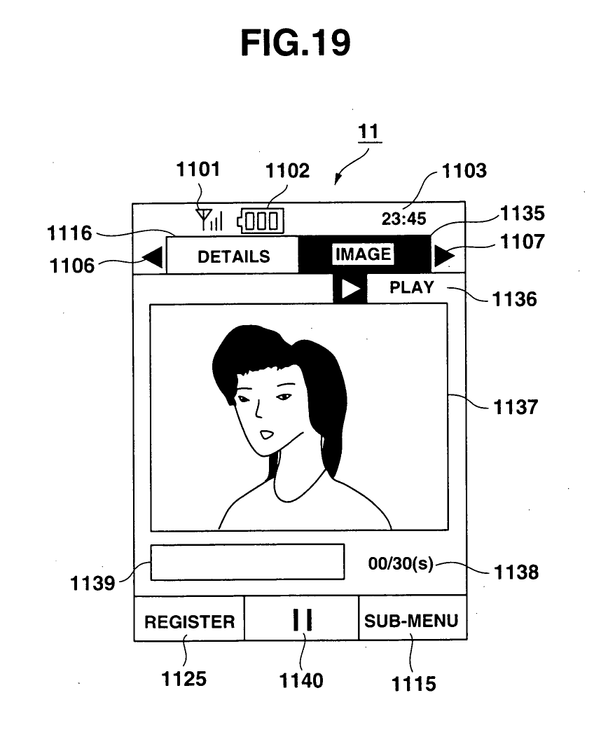

If there is a moving image file in the image memory 36 registered as a link destination, the control section 21 reads out the moving image file in step S71, and causes the image processing section 37 to decompress the file. In step S72, the control section 21 plays back the moving image on the display section 11 as shown in FIG. 19.

If the control section 21 detects the end of the playback by checking in step S73 whether or not the playback is complete, the flow automatically returns to the display of detailed outgoing call information in step S35. If the control section 21 checks in step S74 during the playback whether or not the operation of the accept key 123 is detected, and detects the operation, the control section 21 pauses the playback frame at the time of detection in step S75. In this paused state, the control section 21 checks in step S76 again whether or not the accept key 123 has been operated. If YES in step S76, the control section 21 resumes playback from this point of time.

If the control section 21 does not detect the operation of the accept key 123 in step S76, the control section 21 checks in step S77 whether or not the operation of the clear key 129 is detected.

If the operation of the clear key 129 is detected in step S77, the control section 21 stops the moving image playback processing, and the flow returns to the display of detailed outgoing call information in step S35. If the operation is not detected, the control section 21 maintains the paused state in step S75. If the operation of the accept key 123 is not detected in either of steps S74 and S76, the control section 21 keeps playing back a moving image.

When the operation of this flow chart is executed upon detection of a photograph display instruction in step S45, moving image playback processing and a paused display state are the same as those in the above operation. When the playback is complete, however, the flow shifts to detailed information display in step S44. In addition, if a moving image file is linked to outgoing call log information, the image data of the start frame (I picture) of the corresponding moving image file is resized and displayed in place of the resized image data 1127 in the display state shown in FIG. 13.

FIG. 19 shows the display state in step S72. Referring to FIG. 19, the display section 11 displays an icon 1101 indicating a radio reception state, an icon 1102 indicating the remaining battery capacity, a current time 1103, a “details” tab 1116, a “photograph” tab 1117, an icon 1106 for scrolling detailed information in the forward direction in list order, an icon 1107 for scrolling the detailed information in the reverse direction in list order, an indicator 1136 indicating that a moving image is being played back, a moving image playback window 1137, a total playback time 1138, a currently displayed playback time gage 1139, a display area 1125 for, when this incoming call log is to be newly registered in the address book data storage area 223, prompting the user to operate the camera key 121 as the corresponding key, a display area 1140 for, when a pause instruction is to be issued, prompting the user to operate the accept key 123 as the corresponding key, and a display area 1115 for, when an instruction is to be issued to perform data editing, e.g., editing/deleting/registering highlighted data, prompting the user to operate an address book key 122.

As described above, according to the second embodiment, if there is a moving image file linked to predetermined data in an outgoing call log, a moving image can be directly played back from the outgoing call log data and can be paused at an arbitrary timing.

Although not described in detail in this embodiment, when an outgoing call log with images or enlarged image data is displayed, the image data stored in the image memory 36 is resized to be optimally displayed. However, the image sensed by the image sensing section 34 may be stored on the basis of the DCF (Design rule for Camera File system) specifications, and thumbnail images generated at this time may be used for the display of an outgoing call log with images or enlarged display.

The operation of each of the above embodiments can be programmed and executed by a computer. In this case, the computer program can be supplied to the computer through various kinds of program recording media, e.g., disk type recording media such as a flexible disk and hard disk, various kinds of memories such as a semiconductor memory and card type memory, and a communication network.

In addition, the present invention is not limited to the above embodiments, and the specific arrangements, functions, operations, and effects of the embodiments can be implemented in other various forms. The same effects as those described above can be obtained by applying the present invention to communication terminals in various forms such as a PDA and portable personal computer which have photographing functions.

What is claimed is:

1. A portable communication terminal comprising:
display means;
image storage means for storing image data;
address book data storage means for storing at least one piece of contact address information and various information associated with the contact address information upon establishing a link therebetween;
storage means for storing a link between specific data in the address book data storage means and a storage address of image data stored in the image storage means;
communication log storage means for storing, as a communication log, contact address information transmitted and/or received by the portable communication terminal;
first instructing means for instructing to display a communication log on the display means;
first display control means for, when detecting an instruction from the first instructing means, listing/displaying the contact address information stored in the communication log storage means on the display means;
second instructing means for instructing to display a communication log with an image on the display means when list display is performed by the first display control means;
first determination means for, when detecting an instruction from the second instructing means, referring to the storage means to determine whether image data is linked to the contact address information displayed on the display means; and
second display control means for, when the determination means determines that image data is linked, reading out and resizing the image data and listing/displaying the data, together with the contact address information.

2. A terminal according to claim 1, wherein the portable communication terminal further comprises second determination means for determining whether or not information identical to contact address information stored in the communication log storage means is present in the address book data storage means, and
the first display control means causes the display means to display various information associated with the contact address information in place of the contact address information when the second determination means determines that the information is present.

3. A terminal according to claim 1, further comprising:
first selection means for selecting specific contact address information from the contact address information listed/displayed on the display means; and
third display control means for, when contact address information is selected by the first selection means, causing the display means to display a communication state when communication is made in accordance with the contact address information.

4. A terminal according to claim 2, further comprising:
second selection means for selecting specific various information from the various information listed/displayed on the display means; and
fourth display control means for, when specific various information is selected by the second selection means, causing the display means to display the various information and a communication state when communication is made.

5. A terminal according to claim 4, wherein
the various information includes a plurality of pieces of contact address information, and
the fourth display control means controls to display said plurality of pieces of contact address information and an icon indicating attributes thereof.

6. A terminal according to claim 3, further comprising:
third determination means for determining in accordance with display performed by the third display control means whether or not a list display instruction is detected; and
fifth display control means for, when a list display instruction is issued by the third determination means, causing the first display control means to perform list display if display is performed by the third display control means through list display by the first display control means, and causing the second display control means to perform list display if display is performed by the third display control means through list display by the second display control means.

7. A terminal according to claim 4, further comprising:
fourth determination means for determining in accordance with display performed by the fourth display control means whether or not an image data display instruction is issued; and
sixth display control means for, when an image data display instruction is issued by the second determination means, reading out image data on the basis of a storage address of image data linked and stored in the storage means, resizing the image data, and displaying the data on the display means in place of display by the fourth display control means.

8. A terminal according to claim 1, wherein
the first display control means separately displays an outgoing call log and an incoming call log as the communication log and further comprises:
third instructing means for instructing to display an outgoing call log;
fourth instructing means for instructing to display an incoming call log; and
seventh display control means for switching and displaying an outgoing call log and an incoming call log every time each of instructions from the third and fourth instructing means is detected.

9. A terminal according to claim 1, further comprising eighth display control means for causing the display means to always display a reception state of the radio signal.

10. A terminal according to claim 7, wherein
the image data includes moving image data, and
when the image data is moving image data, the sixth display control means plays back a moving image based on the moving image data.

11. A terminal according to claim 1, further comprising:
image sensing means; and
storage control means for causing the image storage means to store image data sensed by the image sensing means.

12. An image display method for a portable communication terminal including a display section, an image memory which stores image data, and an address book data memory, comprising:
a storage step of causing a predetermined memory to store a link between specific data in the address book data memory and a storage address of image data stored in the image memory;
a communication log storage step of causing a communication log memory to store, as a communication log, contact address information transmitted and/or received by the portable communication terminal;
a first instructing step of instructing to display a stored content of the communication log memory on the display section;
a first display control step of, when detecting an instruction issued in the first instructing step, listing/displaying the contact address information stored in the communication log memory on the display section;
a second instructing step of instructing to display a communication log with an image on the display section when list display is performed in the first display control step;
a first determination step of, when detecting an instruction issued in the second instructing step, referring to the predetermined memory to determine whether image data is linked to the contact address information displayed on the display section; and
a second display control step of, when it is determined in the determination step that image data is linked, reading out and resizing the image data and listing/displaying the data, together with the contact address information, on the display section.

13. A method according to claim 12, wherein the image display method further comprises a second determination step of determining whether or not information identical to contact address information stored in the communication log memory is present in the address book data memory, and
in the first display control step, the display section is caused to display various information associated with the contact address information in place of the contact address information when it is determined in the second determination step that the information is present.

14. A method according to claim 12, further comprising:
a first selection step of selecting specific contact address information from the contact address information listed/displayed on the display section; and
a third display control step of, when contact address information is selected in the first selection step, causing the display section to display a communication state when communication is made in accordance with the contact address information.

15. A method according to claim 13, further comprising:
a second selection step of selecting specific various information from the various information listed/displayed on the display section; and
a fourth display control step of, when specific various information is selected in the second selection step, causing the display section to display the various information and a communication state when communication is made.

16. A method according to claim 15, wherein
the various information includes a plurality of pieces of contact address information, and
in the fourth display control step, said plurality of pieces of contact address information and attributes thereof are displayed.

17. A method according to claim 14, further comprising:
a third determination step of determining in accordance with display performed in the third display control step whether or not a list display instruction is detected; and
a fifth display control step of, when a list display instruction is issued in the third determination step, performing list display in the first display control step if display is performed in the third display control step through list display in the first display control step, and performing list display in the second display control step if display is performed in the third display control step through list display in the second display control step.

18. A method according to claim 15, further comprising:
a fourth determination step of determining in accordance with display performed in the fourth display control step whether or not an image data display instruction is issued; and
a sixth display control step of, when an image data display instruction is issued in the second determination step, reading out image data on the basis of a storage address of image data linked and stored in the predetermined memory, resizing the image data, and displaying the data on the display section in place of display in the fourth display control step.

19. A method according to claim 18, wherein
the image data includes moving image data, and
in the sixth display control step, when the image data is moving image data, a moving image based on the moving image data is played back.

20. A method according to claim 12, wherein the portable communication terminal further comprises an image sensing section, and the method further comprises a storage control step of causing the image memory to store image data sensed by the imaging sensing section.
